(19) United States
(12) Patent Application Publication
(10) Pub. No.: US 2007/0063498 A1
(43) Pub. Date: Mar. 22, 2007

(54) Passenger vehicle safety apparatus

(76) Inventor: Kevin L. Hollander, Winston-Salem, NC (US)

Correspondence Address: WILLIAM ANTHONY DRUCKER;Suite 800, 1901 L Street, N.W., WASHINGTON, DC, 20036-3506, US

(21) Appl. No.: 11/503,380

(22) Filed: Aug. 11, 2006

Related U.S. Application Data
(60) Provisional application No. 60/718,385, filed on Sep. 19, 2005.

(51) Int. Cl. B60R 21/02; B60R 21/16; A47C 31/00

(52) U.S. Cl. 280/748; 280/801.1; 280/733; 297/488; 280/728.1

(57) ABSTRACT

Vehicular air bag safety system comprising the combination of (a) a compressed air bag for passenger collision impact management; (b) a passenger safety harness worn by a vehicle occupant and (c) a layer of pressure deformable energy absorbing minimally resilient force insulation disposed between the occupant and the air bag.

This invention relates to improvements in vehicular safety management, and more particularly to passenger safety and collision impact control.

It is recognized that deployment of safety impact air bags may result in passenger injury from the concentrated force of the explosion of an expanding bag against the person of the driver or passenger. Wider distribution and/or attenuation of impact force provides protection from the violence of bag expansion and conserves the air bag safety benefit of the cushion effect.

The release of energy at impact from an air bag safety device is absorbed and dissipated by deformation of a material located between the passenger and an air bag at the time of impact. Deformation by crushing generates heat. Conversion of mechanical energy or energy of motion into heat is substantial. For example, the energy of a moving automobile, dissipated by its brakes (e.g. 60 mph to a full stop) shows the conversion of substantial mechanical energy of motion into frictional heat or thermal energy.

It is an object of this invention to provide an article of manufacture, which dissipates the force of air bag impact to an extent, which reduces bag impact injury and preserves safety benefit of the bag during collision.

A further object of the invention is to provide a method of operation of an air bag vehicle safety system, which reduces air bag injury during collision deployment of air bag safety devices.

According to a preferred version and best mode of the invention, a segmented cellular fabric product is positioned between the air bag and the person of the passenger. Force absorbing cells are deployed in a fabric matrix to deform on sudden compression exceeding a preset value by virtue of their contents or cellular construction so that force of impact is attenuated and dissipated, thereby reducing risk of bag injury to passengers.

The preferred article of manufacture deployed in this invention is made of woven or non-woven sheet material and is incorporated in a garment, shield-member, corset, vest, belt or harness, or a combination of these structures. The article in a further embodiment is integral with the air bag structure per se.

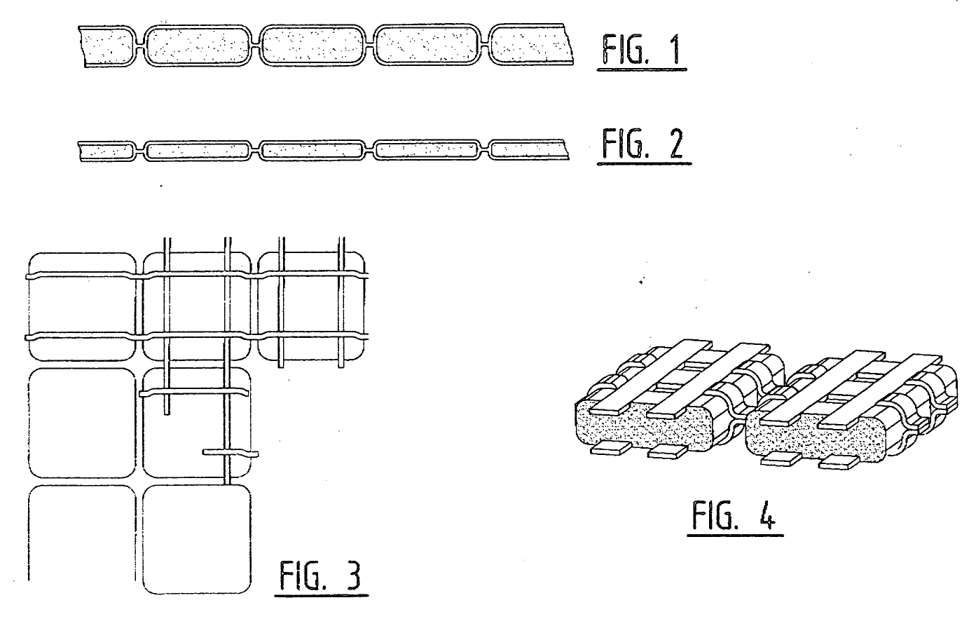

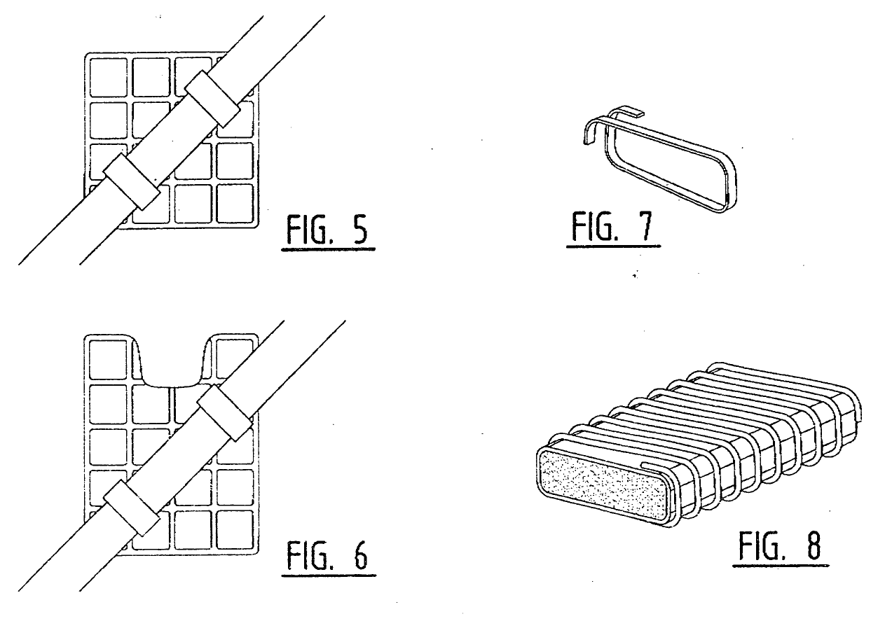

FIG. 1 illustrates quilted impact pallets before impact in a passenger worn garment, which incorporates several, single impact or one use controlled deformable safety elements according to a first embodiment of this invention.

FIG. 2 shows the crushing effect of impact by an air bag on the inner elements of a garment of FIG. 1.

FIGS. 1 and 2 use crushable aluminum sheet pallets. Foam pallets provide similar crush results. Cement, ceramic or composite brittle material form multiple small fragments or a sand-like grit.

FIG. 2 is an exploded cut away view of a cellular section of the garment of FIG. 1 showing the internal cellular deployment of multiple crushable impact protection elements prior to air bag impaction.

FIG. 3 shows internal impaction elements after bag impaction and element deformation by air bag force.

FIG. 4 shows the use of springs which deform on impact and then return at least partly to original shape and thus function in repeated impacts, for example, during the normal compression of driving before air bag explosion. More detail is seen in criss-cross construction.

FIG. 5 shows direct attachment of the safety device to a seat belt or harness.

FIG. 6 shows a safety harness and vest device worn by a driver or passenger.

FIG. 7 shows use of a flat coil spring according to this invention.

FIG. 8 shows coil springs which are used with crushable elements to provide protection of the device in minor impacts.

It is important that the protective deformable elements are not dense and are of light weight to protect the user from harm by the device in severe impacts. The elements are mounted in woven fabric sheet material in the best mode form.

1. Vehicular air bag safety system comprising the combination of
(A) a compressed air bag for passenger collision impact management;
(B) a passenger safety harness worn by a vehicle occupant and
(C) a layer of pressure deformable energy absorbing minimally resilient force insulation disposed between the occupant and the air bag.

2. Method of vehicle collision safety management comprises the steps of locating an occupant in a vehicle between a seat and an expandable safety air bag and arranging a layer of crushable force insulation between the occupant and the bag which layer absorbs the force of collision and protects the occupant from air bag injury.
